(19) United States
(12) Patent Application Publication
(10) Pub. No.: US 2005/0093443 A1
(43) Pub. Date: May 5, 2005

(54) Plasma display device and control method therefor

(76) Inventors: Jacques Pelletier l, Saint-Martin-D'Heres (FR); Ana Lacoste, Saint-Martin-Le Vinoux (FR); Yves Arnal, Poisat (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/499,994

(22) PCT Filed: Dec. 23, 2002
(86) PCT No.: PCT/FR02/04522

(30) Foreign Application Priority Data
Dec. 24, 2001 (FR) 01/16820

(51) Int. Cl. H01J 17/49

(52) U.S. Cl. 313/582

(57) ABSTRACT

The invention concerns a plasma display device-comprising in a screen a chamber (17) containing a discharge gas capable of being excited to generate, alone or in combination with luminophor means (18) themselves designed to be excited by a radiation emitted by said gas, a visible light. The device comprises means for generating on one side of said chamber (17) a uniformly distributed electric field (E) designed to ignite a plasma in the gas, as well as a matrix of controllable elements (19) and means controlling said elements (19) so that they modulate individually the electric field (E) or the radiation emitted by the plasma or the generated visible light thereby generating selectively luminous zones on the screen.

### TECHNICAL DOMAIN OF THE INVENTION

This invention relates to the domain of plasma display screens or panels. In particular, it relates to television wall plasma screens.

### DESCRIPTION OF THE STATUS OF THE ART

Plasma screens generally include a network of cells confined between two parallel glass plates. Each cell is controlled by at least one pair of electrodes in contact with the discharge gas. When enough voltage is applied between the two electrodes, a discharge is generated in the gas contained in the cell. This discharge makes the gas release an ultraviolet radiation. The walls of the cells are covered with phosphors that transform the invisible radiation (ultraviolet radiation) that it receives into visible radiation (colour.)

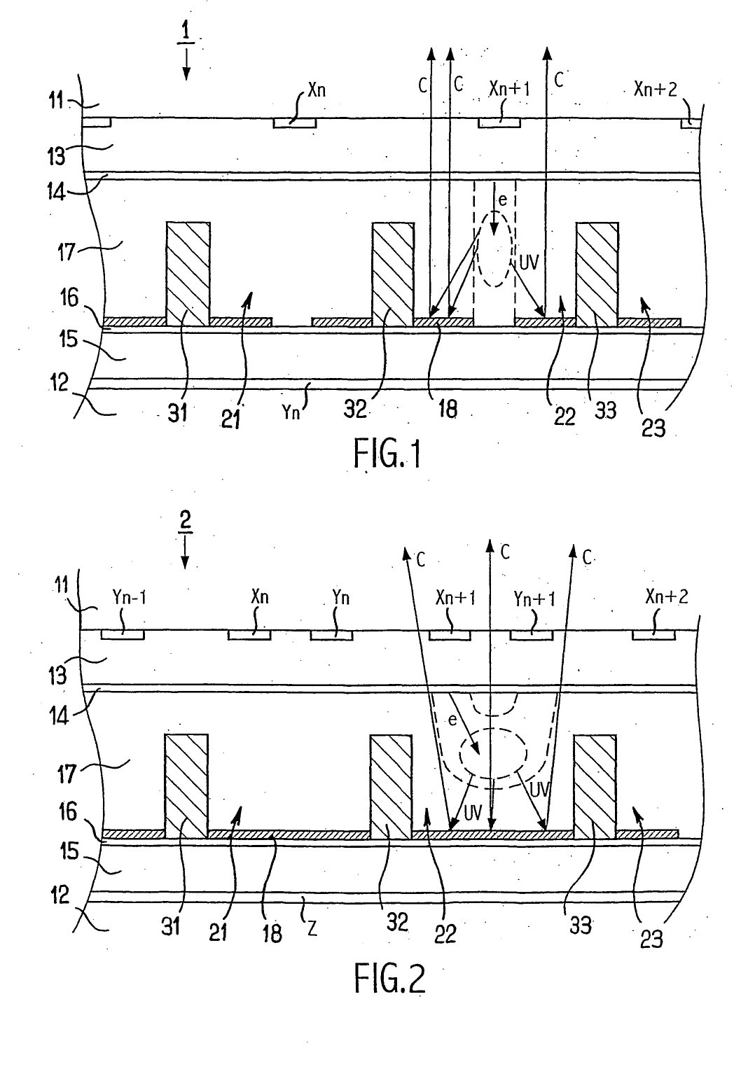

Currently, there are two types of screen structures represented in FIGS. 1 and 2. On these Figures, elementary cells 21, 22, 23 separated by barriers 31, 32, 33 are confined between two glass plates 11 and 12 that extend perpendicularly to the barriers. Phosphor layers 18 partially cover the internal walls of the cells 21, 22, 23.

FIG. 1 represents a “matrix”-type plasma screen; that is, with an Alternate Current Matrix (ACM) structure 1. On this Figure, the first glass plate 11 includes a network of parallel electrodes Xn, Xn+1, Xn+2, etc. on its internal surface. Each electrode Xn, Xn+1, Xn+2, etc. corresponds to a display line of the screen. The electrodes are embedded in a thick layer 13 (thickness of approximately 20 μm) of dielectric material comprised of, for example, enamel. This layer 13 is covered by a layer 14 of dielectric material (thickness less than 1 μm) comprised of, for example, magnesium oxide (MgO) whose surface is in contact with the discharge gas. The second glass plate 12 also includes a network of parallel electrodes Yn, Yn+1, etc. on its internal surface and is positioned perpendicularly to the electrodes of lines Xn, Xn+1, Xn+1, etc. of the first glass plate 11 and making up column electrodes. As with the line electrodes Xn, Xn+1, Xn+1, etc., these electrodes are embedded in a thick layer 15 of dielectric material that could be covered by a thin layer 16 of magnesium oxide.

FIG. 2 represents a “co-planar”-type plasma screen; that is, having a Alternating Co-planar Current (ACC.) In this structure, the two electrode networks Xn, Xn+1, Xn+2 and Yn, Yn+1, etc. are arranged in parallel, in an interleaved manner, on the same glass plate 11. An addressing electrode network Z is submerged in the opposite glass plate 12.

In the two screen structures 1 and 2 represented in FIGS. 1 and 2, the two electrode networks Xn, Xn+1, Xn+1 and Yn, Yn+1, etc. control the lighting up (normally called “breakdown” by those skilled in the art) of the plasma contained in each cell 21, 22, 23. Indeed, the electrodes Xn, Xn+1, Xn+2 and Yn, Yn+1, etc. form, with dielectric layers 13 or 15 in which they are embedded, a capacity that can store electrical charges on its surface and through which the necessary voltage is applied to create or maintain a light discharge (represented by the dotted line) in the plasma.

The operation of these discharges is similar to that of the dielectric barrier discharges (DBD), simple luminescent high-pressure discharges. When a discharge is provoked between two electrodes X and Y, the magnesium oxide (MgO) layer 14 in contact with the plasma undergoes a bombardment of ions present in the discharge and emits electrons e under the effect of this bombardment. The magnesium oxide layer 14 plays a crucial role in obtaining a high secondary electron emission coefficient under ionic impact. This secondary emission of electrons e allows maintaining the discharge with the voltages between electrodes X and Y as weak as the secondary emission coefficient is high.

In response to the discharge, the plasma emits UV rays. The phosphors 18 that absorb the UV rays re-emit a radiation C in a visible frequency. The phosphors 18 are, for example, arranged in bands of cells of the plasma screen. Each screen band emits in a basic colour: red, green, or blue. The phosphors 18 are thus distributed in the screen according to a repetitive pattern of three consecutive bands, each with a different emission colour.

Given the purely capacitive operating mode of the basic cells 21, 22, 23, the lighting up and extinction of the cells are controlled by the overlapping of electric pulses, that is: an alternating “maintenance” voltage (with a frequency of approximately 50 to 100 kHz), applied continually between electrodes X and Y of a cell and less than the plasma breakdown voltage, a “light up” pulse to exceed the cell light up voltage, and a “clearing” pulse to cancel the electric charge maintained by the alternating voltage at the surface of the dielectric barriers. The plasma is therefore excited by a stream of pulse discharges created by the alternating maintenance voltage between the light up pulse and the clearing pulse. The current pulse of the impulse discharge lasts approximately 100 ns, during which time, the electrons e excite and ionise the gas. The drop in voltage between the dielectric barrier surfaces due to the presence of the plasma provokes the stopping of the discharge until the new maintenance alternating pulse is applied. The excited plasma and atoms then release the photons generated at each current pulse. In the case of a Neon-Xenon mixture, the UV photons emitted by the Xenon, (in particular, after the resonant level Xe(³P₁) and the excimers) therefore excite the phosphors 18, generally arranged outside the active areas of electrodes, which re-emit visible photons.

The typical operating values of plasma cells, for mixtures of Neon-Xenon at sub-atmospheric pressure of the sparkover voltages, are between 250V and 300V, and the maintenance voltages included are between 150V and 200V. The breakdown voltage depends on the product of the pressure by the inter-electrode distance whose minimal value is approximately 5 to 10 torr×cm. The current density during the impulse discharge can reach 5 to 10 A/cm². The density of the plasma is approximately 10¹¹ to 10¹⁴ cm⁻³ and the electronic temperature is of a few eV.

Other variants of the technology described above were and are the object of important investigations and development (plasma maintenance by radio frequency voltage), but the operating principle of flat screens, based on dielectric barrier discharges, remains the same.

An inconvenience of the previously described techniques is that the operating window of the plasma (gap between the extinction or clearing voltage and the breakdown voltage) is narrow, which leads to a relative complexity of the cell addressing and forces an unfavourable compromise as regards to light efficiency.

Indeed, the existence of a maintenance threshold of the discharge (extinction discharge) that is lower than the breakdown discharge is essential for the operation of the cells that can pass from the off status to the lit status, and vice versa, using light up and clearing pulses that modify the electric charge of the cell. Because none of the cells in the plasma screen is identical, it is preferable that the gap between the breakdown voltage and the extinction voltage is not too low for the operating points of all the screen cells to fall within the scope of this margin.

In the case of a Neon-Xenon mixture, this margin increases in proportion to the Xenon in the Neon-Xenon mixture. This is because the sparkover voltage increases in proportion to the Xenon because of the low secondary emission coefficient of Xenon ions with respect to Neon ions. Therefore, the increase in maintenance and breakdown voltages leads to an increase in complexity and a loss of command and transport circuits of the electric power.

As a result, to reduce the sparkover voltage, the Xenon proportion in the gas must be limited, which correlatively reduced the UV efficiency of the plasma. In this case, the margin between the breakdown voltage and the extinction voltage becomes quite small, which forces a more refined adjustment of the control pulses.

Lastly, the spectral interference of the three types of pulses (maintenance, light up, and clearing), to be finely tuned, makes the addressing function relatively complex.

Another drawback of existing plasma screens is that the cell control requires high voltage pulses and peak currents that can only be generated through power electronic circuits. Therefore, these circuits represent an important part of the cost of plasma screens.

Furthermore, the complexity of the cell addressing, based on the memory effects of the electric charges with respect to the electrodes, also participates in the high cost of control-electronics.

Another drawback of existing plasma screens is that they present a mediocre lighting efficiency, inherent to the discharge operating mode.

Indeed, the efficiency of current plasma screens is approximately from 1 to a few lm/W (lumen per Watt), which means that only a small percentage of the electric energy dissipated by the cell is converted into visible light. The main factors that control the light efficiency are the following (in logical order based on the conversion sequence):
the power dissipated in the command and addressing circuits,
the UV efficiency of the discharge; that is, the relationship between the energy emitted in the form of UV photons and the energy injected into the plasma,
the efficiency of the UV collection by the phosphors,
the conversion efficiency of UV photons into photons that are visible by the phosphors,
the efficiency of the visible photon collection.

As regards to the power dissipated in the command and addressing circuits, this power can be reduced by reducing the sparkover and maintenance voltages, but at the cost of UV efficiency as previously indicated.

The choice of gas or mixture of gases determines the efficiency in UV photons. In parallel, the presence of an MgO layer, as the secondary electron material, forces the use of rare gases that do not modify the surface properties (the secondary emission coefficients are sensitive to surface modifications.) In the case of a Neon-Xenon mixture, the Xenon is an efficient UV emitter while the Xenon is an efficient emitter of secondary electrons through the ionic bombardment of MgO. Consequently, a low breakdown voltage can be obtained by using low Xenon mixtures (percentage lower than 10%.) Therefore, it is observed that in an electric barrier charge type cell, an important part of the energy injected in the plasma, is transferred not only in the Neon atom excitement and ionisation phases (where the excitement and ionisation are much greater than those of Xenon), but also in the ionic bombardment of MgO to the dielectric barrier surface (and the collisions with the neutrons in the classical diffusion ionic tubes.) In other words, the energy injected in a cell is dissipated principally in unproductive losses, inherent to the operating mode of dielectric barrier discharges.

The efficiency of the collection of UV photons by the phosphors is also an important factor in cell efficiency. Indeed, the photons that hit the uncovered phosphor surfaces; that is, the surfaces covered by the MgO layer, are lost, which greatly affects the overall efficiency of the cell.

The efficiency of the conversion of UV photon phosphors into visible photons does not depend on the cell structure or the characteristics of the plasma, but rather only on the intrinsic efficiencies of the phosphors. Currently, the conversion efficiency obtains values of approximately 20 to 25%.

Lastly, in the final light efficiency of the percentage of visible photons that can cross the front of the screen, some are lost on the back of the screen and others absorbed upon the crossing of the electrodes or the dielectric layers present (MgO, enamel.)

Another drawback of existing plasma screens is the complexity of the cell structure that makes their manufacture a complex process. The manufacture of plasma screens represents an important part of their final cost.

Lastly, another inconvenience of existing plasma screens is the relatively short lifespan of the cells.

The limitation of the cell lifespan is due to the progressive sputtering of the magnesium oxide layer, whose thickness is limited, under the effect of ionic current pulses. Once the magnesium oxide layer has been completely sputtered, the underlying thick dielectric layer, which does not have such a high secondary emission coefficient, does not emit sufficient quantity of secondary electrons to allow lighting the discharge. The cell therefore remains in an off status permanently.

The limitation of the cell lifespan is also due to the degradation of the phosphor efficiencies over time. This degradation is generally attributed to the action of the UV rays that would considerably affect the chemical composition of the phosphor surface, in particular, by the photo-desorption of volatile elements such as oxygen in the case of oxides.

An objective of the invention is to offer a plasma screen that has improved efficiency techniques: better light efficiency, simplified cell structure, and a longer lifespan.

### SUMMARY OF THE INVENTION

To this end, the invention offers a plasma display device of the type that includes in a screen a chamber that encloses a discharge type gas that can be excited in order to generate, either on its own or in combination with phosphor means designed themselves to be excited by radiation emitted by said gas, a visible light. The device includes means for generating, on one side of said chamber an evenly distributed electric field that can light a plasma in said gas, as well as, on the one hand, a matrix of controllable elements, and on the other hand means that control said elements.

In an embodiment of the invention, the controllable element matrix is arranged between the electric field and the gas and the control means control the elements so that they individually modulate the electric field and thus selectively generate light areas on the screen.

In another embodiment of the invention, the controllable elements matrix is arranged between the gas and the phosphors and the control means control said elements so that they individually modulate the radiation emitted by the plasma and intended to be received by the phosphors, and thus selectively control the light that appears on the screen.

In another embodiment of the invention, the controllable element matrix is arranged downstream from the gas or the phosphor means and the control means control said elements so that they individually modulate the visible light generated, and thus selectively control the light that appears on the screen.

In such a device, the functions of power injection and light control on the screen are separated: the power is supplied by means that generate electric fields, whereas the control of the light that appears on the screen is performed by controllable elements.

As a result of this separation, the power required for controlling the controllable elements is reduced with respect to the powers required in the command circuits of the previous art's plasma devices.

Correlatively speaking, the dissipated power in the command is reduced.

Furthermore, given this disassociation, the injection of power is done in a more efficient manner. Thus, the device of the invention can operate independently of the gaps between the breakdown electric field and the extinction electric field. Consequently, good light efficiency can be obtained by choosing gases or gas mixtures that allow optimising the production of photons.

Lastly, the device of the invention has a simplified structure, which allows reducing the cost of manufacture.

In preferred embodiment of the invention, the electric field is generated by microwaves. The plasma is therefore not excited by polarised electrodes, as is the case in the devices of the previous art. This allows eliminating the problem of sputtering of walls due to ionic bombardment. The UV efficiency and the lifespan of the device are improved. Furthermore, this device does not need an MgO dielectric layer.

### PRESENTATION OF DIAGRAMS

Other features and advantages will be made more apparent from the description that follows, which is purely for illustration purposes and is non-limiting, and must be read whilst viewing the attached diagrams, in which:

FIGS. 1 and 2 already mentioned are diagrams that represent, in cross section according to a line of cells of plasma screen structures of the previous art, a matrix-type plasma screen structure and a coplanar-type plasma screen structure, respectively,

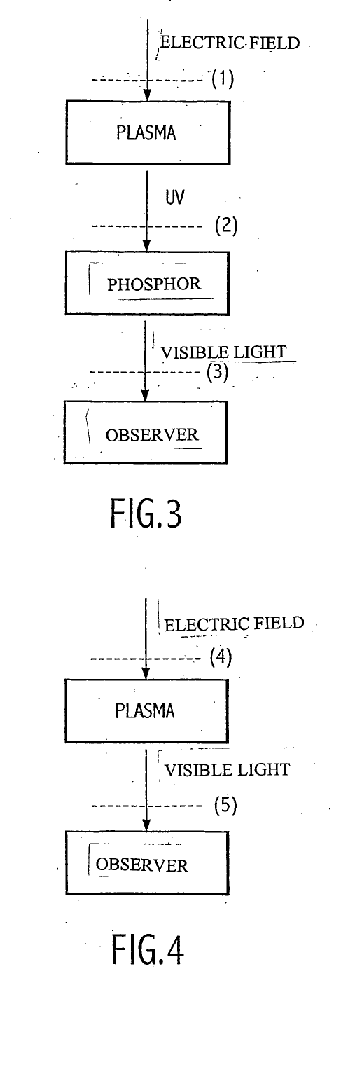

FIGS. 3 and 4 are block diagrams that illustrate the operation of two types of plasma screen structures,

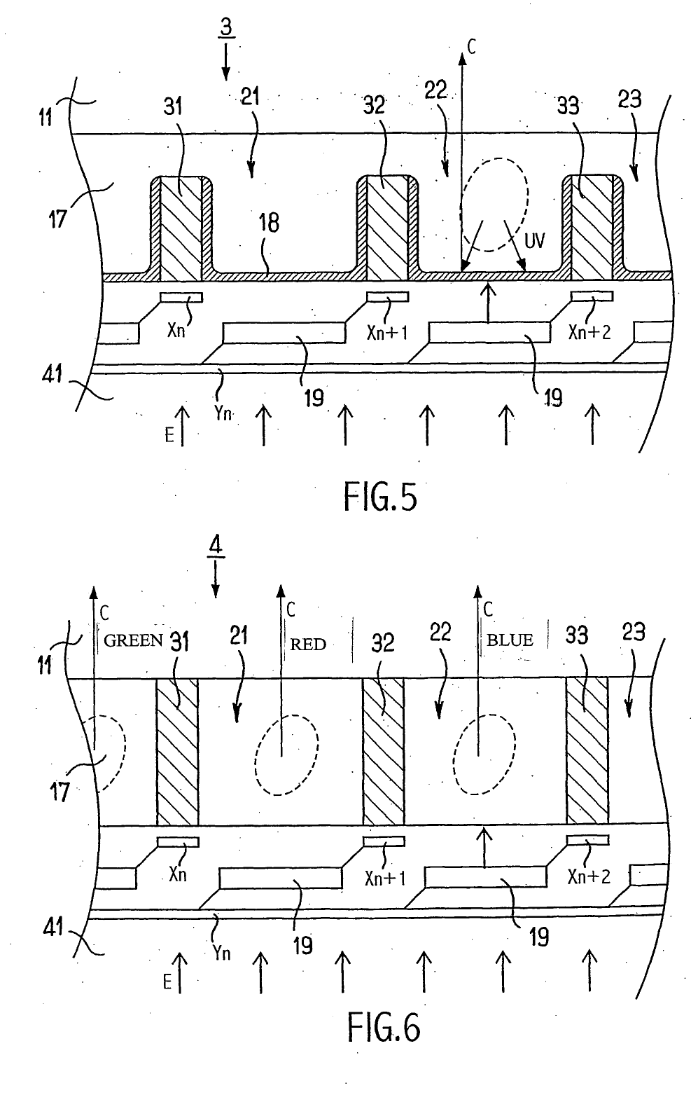

FIG. 5 is a diagram that represents, in cross section according to a line of cells, a plasma screen structure according to an embodiment of the device of the invention,

FIG. 6 is a diagram that represents in cross section according to a line of cells, a plasma screen structure according to an embodiment variant of the device in FIG. 5,

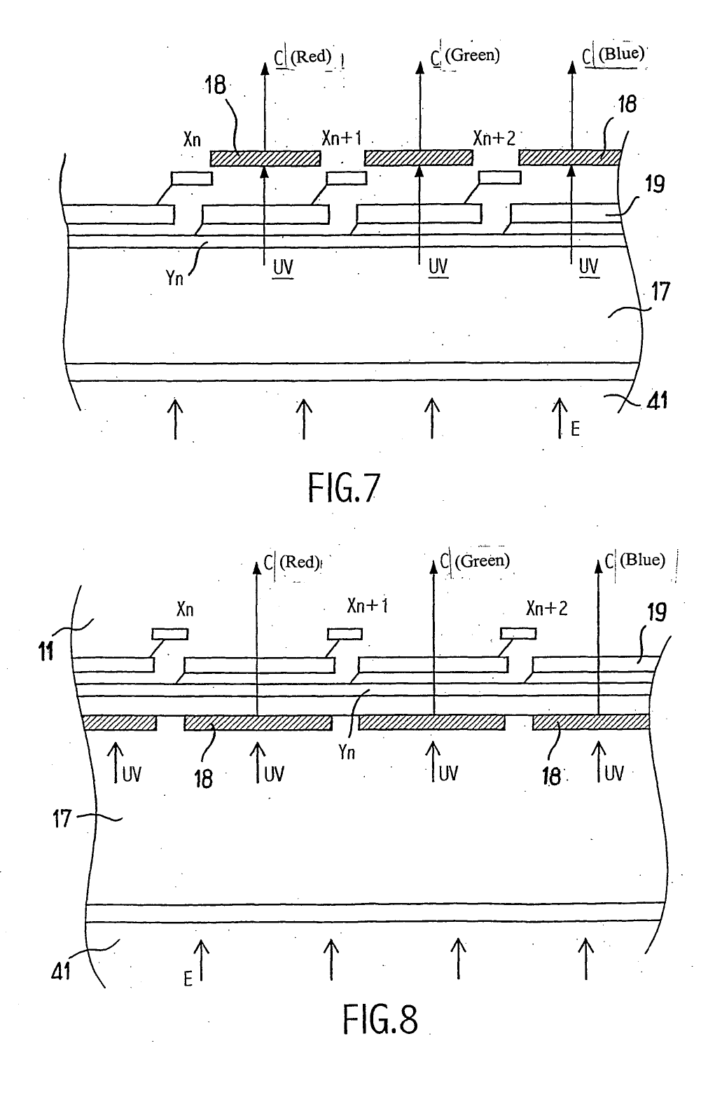

FIG. 7 is a diagram that represents in cross section according to a line of cells, a screen structure according to a second embodiment of the device of the invention,

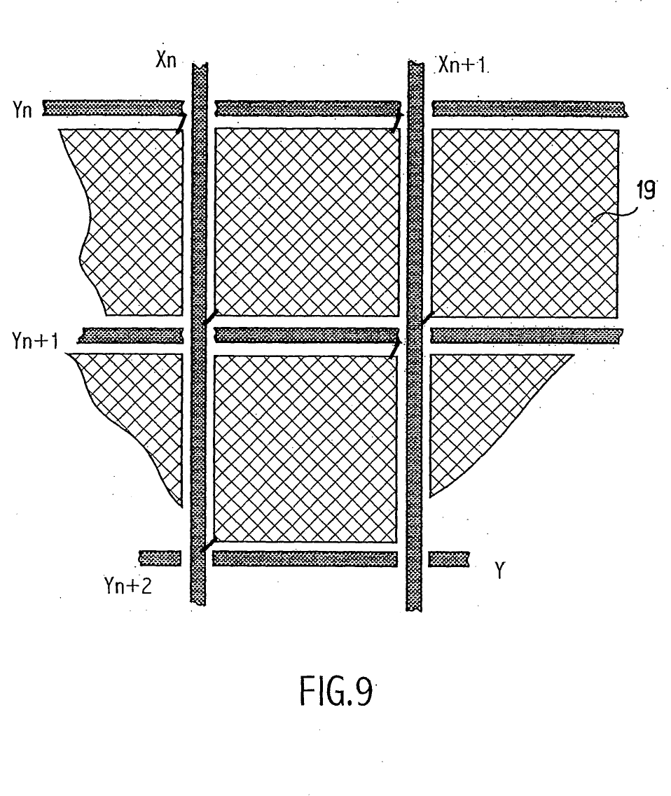

FIG. 8 is a diagram that represents in cross section according to a line of cells, a screen structure according to a third embodiment of the device of the invention,

FIG. 9 is a diagram that represents the rear view of a command device of the cells than can be used in a device of the invention.

### DESCRIPTION OF DIAGRAMS

FIG. 3 is a block diagram that illustrates the operation of a plasma screen in accordance with the invention of the type that includes phosphors.

According to this diagram, an electric field E is generated and evenly distributed close to a chamber containing gas. When this field is applied to the gas, it generates a plasma that emits ultraviolet radiation. This radiation is directed towards a phosphor that absorbs the ultraviolet radiation and re-emits radiation that is visible to the observer looking at the screen.

According to a first configuration, a matrix of controllable elements is positioned in (1), between the electric field and the gas. The control means control the elements so that they individually modulate the electric field transmitted to the gas, and thus control the light generated on the screen. In this configuration, the intensity of field E is greater than the light intensity of the plasma.

According to a second configuration, a matrix of controllable elements is positioned in (2), between the gas and the phosphors. The control means control the elements so that they individually modulate the UV radiation emitted by the plasma and intended to be received by the phosphors, and thus selectively control the light that appears on the screen. In this configuration, the electric field E is applied continuously to the gas and distributed so that a uniform plasma is continuously generated. The electric field E therefore has, in a continuous manner, an intensity greater than the maintenance intensity of the plasma. The intensity must not be greater than the light intensity of the plasma than when the screen is activated.

According to a third configuration, a matrix of controllable elements is positioned in (3), downstream from the phosphor means (that is, between the phosphors and the outside observer). The control means control the elements so that they individually modulate the visible light generated by the phosphors and thus selectively control the light that appears on the screen. Similarly, when the controllable elements are positioned in (2), the electric field E has, continuously, an intensity that is greater than the maintenance intensity of the plasma, and when the screen is activated, an intensity that is greater than the lighting intensity of the plasma.

FIG. 4 is a block diagram that illustrates the operation of a plasma screen in accordance with the invention of the type without phosphors.

According to this diagram, an electric field E is generated and evenly distributed next to a chamber that contains gas. When this field is applied to the gas, it generates a plasma that emits radiation that is visible to the observer that looks at the screen.

This type of structure allows, in particular, creating “black and white” screens.

In the case where the screen includes a plasma chamber divided into cells, the cells can include different gas compositions. Each cell thus generates radiation in a colour (generally green, red, or blue) depending on the composition of the gas it contains. A “colour” screen is thus obtained.

According to a first configuration, a matrix of controllable elements is positioned in (4), between the electric field and the gas. This configuration is similar to configuration (1) in FIG. 3. The control means control the elements so that they individually modulate the electric field transmitted to the gas and thus control the light generated on the screen. In this configuration, the intensity of field E is greater than the light intensity of the plasma.

According to a second configuration, a matrix of controllable elements is positioned in (5), downstream from the plasma(s). This configuration is similar to configuration (3) in FIG. 3. The control means control the elements so that they individually modulate the visible light generated by the plasma(s) and thus selectively control the light that appears on the screen. The electric field E has, continuously, an intensity that is greater than the maintenance intensity of the plasma, and when the screen is activated, an intensity that is greater than the lighting intensity of the plasma.

FIG. 5 is a diagram that represents a plasma screen structure 3 according to an embodiment corresponding to configuration (1) in FIG. 3.

Structure 3 includes a chamber 17 divided into a matrix of cells, 21, 22, 23 separated by barriers 31, 32, 33 and filled with a gas or gas mixture. Cells 21, 22, 23 are confined between a glass plate 11 that defines the front part of the screen (that is, the side that is directed towards the eyes of the observer) and a cavity 41 that defines the rear side of the screen and in which a uniformly distributed microwave electric field E is generated.

Cavity 41 can, for example, be made of dielectric material with very low loss (for example, silicone oxide SiO₂) and a cooling dielectric liquid. The electric field E can be uniformly distributed, either through a three-dimensional microwave applicator or through microwave resonators, such as ring resonators that are parallel or phase-powered. Here and throughout the document, “microwave” refers to electromagnetic waves with frequencies greater than or equal to 200 MHz. The microwave frequencies used are, for example, ISM (Industrial, Scientific, and Medical) microwave frequencies that are generally used for mass applications (either 433 MHz, 920 MHz, or 2.45 MHz) or frequencies used in mobile telephony. The field E has an amplitude that can light the plasma at the level of each of the cells, and in a very short time (for example, approximately one microsecond).

At least two electrode control networks X and Y are positioned between the cavity 41 and the back of the chamber 17 divided into cells 21, 22, 23. One of the networks X includes at least a series of electrodes Xn, Xn+1, Xn+2, etc. that are vertically positioned, and parallel to the screen columns. The other network Y includes at least a series of electrodes Yn, Yn+1, Yn+2, etc. that are positioned horizontally, in parallel to the lines of the screen.

The controllable elements 19 are connected between each electrode of network X and each electrode of network Y. These controllable elements 19 are positioned behind each cell, between cell 21, 22, or 23 and the cavity 41 of the uniform field E. An element 19 is thus controlled by a pair of electrodes Yn, Xn+2. Depending on the command that it received, element 19 modulates the electric field E transmitted to cavity 41 and cell 22.

As represented in FIG. 9, each of the elements 19 is controlled by at least one given pair of electrodes. This pair is comprised of an electrode of network X and an electrode of network Y. Thus, the electrode networks X and Y individually control the statuses of each element 19 of the element matrix.

Each element 19 can have at least two transmission statuses: a first status according to which it transmits a light up field to cell 22, a second status according to which it transmits a field with a lower maintenance value of the plasma in cell 22.

Such elements 19 can, for example, be comprised of Mechanical Electro Micro Systems (MEMS).

The transmission elements 19 can also be comprised of semiconductor component type structures, such as quantum well structures.

When a cell 22 is activated, the corresponding element 19 is controlled so that it modulates field E to transmit to the cell 22 an electric field that is equal to the light up field. This field generates a discharge in the gas contained in cell 22 that produces UV radiation. The phosphors 18 present on the walls of the cell 22 absorb the UV radiation and re-emit radiation C in a visible frequency.

To maintain the cell 22 lit, the corresponding element 19 must be controlled in order to modulate field E to transmit to cell 22 a field at least equal to the maintenance field of the light up. This voltage maintains the discharge in the gas and thus the production of visible radiation C.

Lastly, to turn the cell 22 off, the corresponding element 19 should be controlled so as to modulate the field E to transmit to cell 22 an electric field that is lower than the maintenance electric field. This electric field is not enough to maintain the discharge in the gas and the emission of visible radiation C stops.

It can be noted that the phosphors 18 cover the walls of the cells on all the surfaces available in order to collect the maximum amount of UV radiation and thus improve the light efficiency of the screen.

FIG. 6 is a diagram that represents a plasma screen structure 4 in accordance with a variant of the invention. This variant corresponds to configuration (4) in FIG. 4.

Structure 4 is similar to structure 3 in FIG. 5, except that the walls of cells 21, 22, 23 are not covered with phosphors. In this variant, the gas contained in chamber 17, under the effect of a discharge, directly generates visible radiation C. This type of structure allows creating “black and white” screens in the case where cells are filled with plasmas made of identical gas compositions or “colour” in the case where cells containing plasmas made of different gas compositions each of which emits visible radiation in one of three basic colours (red, green, and blue.)

FIG. 7 is a diagram that represents a plasma screen structure 5 according to a second embodiment of the invention. This embodiment corresponds to configuration (2) in FIG. 3. In this embodiment, a matrix of controllable elements 19 is positioned between the gas and the phosphors 18. The electrode networks X and Y control elements 19 so that they individually modulate the UV radiation emitted by the plasma and intended to be received by the phosphors 18, and thus selectively control the light that appears on the screen. In this embodiment, the field E is applied continuously to the gas so that a uniform plasma is continuously generated.

FIG. 8 is a diagram that represents a plasma screen structure 6 according to a third embodiment of the invention. This embodiment corresponds to configuration (3) in FIG. 3. The matrix of controllable elements 19 is positioned downstream to the elements that generate visible light. The electrode networks X and Y control elements 19 so that they individually modulate the generated visible light (depending on the plasma(s) or phosphors), and thus selectively control the light that appears on the screen.

In the case of the screen structures in FIGS. 7 and (8) (corresponding to configurations (2) and (3) of FIG. 3), the elements 19 can be comprised of Electro Mechanical Micro Systems (MEMS), Mechanical Opto Electro Micro Systems (MOEMS), or even Photonic Band Gap devices (photonic crystals or BIP) whose transmission status can be controlled.

An advantage of the plasma screens described above is the simplicity of the technology used, both at the cell structure level and their address level, since, on the one hand, the cells are exempt of electrodes, dielectric barriers, and MgO-type secondary emission layers, and on the other hand, by the low voltage circuits that are enough for cell addressing (the transmission element command does not need power electronics.)

Another advantage is the existence of a very large operating window for the excitement of the plasma. The only condition is to apply an electric field that is greater than the breakdown electric field for a given gas or gas mixture at a given pressure. The gas mixture can thus be optimised to obtain the best UV efficiency of the discharge or radiation emission according to well-defined wavelengths. For example, it is possible to obtain a sparkover of the plasma with pure Xenon whose effectiveness is known to produce UV photons. The choice of gas and work pressure is considerably broadened with respect to dielectric barrier discharge plasma screen technologies, which allows choosing the point of operation of the screen cells.

Another advantage is also better light efficiency. Indeed, the energy dissipated in the plasma is completely dedicated to the excitement and ionisation of only efficient atoms (for example, Xenon) for the production of UV photons.

Furthermore, in the case of a microwave electric field, the absence of electrodes eliminates the problem of sputtering of walls due to ionic bombardment. Consequently, this energy is dissipated in this form. Because the walls have floating potential, the energy of the ions on the wall does not exceed ten electron-volts (eV) (approximately.)

Another advantage is due to the absence of electrodes and the absence of MgO deposits with regards to these electrodes. The corresponding location can therefore be occupied by phosphors, which allows improving the light efficiency of the cells.

Lastly, another advantage is the accumulated lifespan of the cells. Indeed, given the absence of an MgO layer and of energetic ionic bombardment, the lifespan of the cells is not linked to their operating lifespan. With the technology used by the invention, the lifespan of the cells is only limited to the lifespan of the phosphors.

It can be noted that in the implementations described corresponding to FIGS. 7 and 8, there is no need for the chamber 17 containing the discharge gas to be divided into cells, given that elements 19 directly control the light up and extinction areas of the screen downstream to the plasma.

1. Plasma display device of the type that includes inside a screen, a chamber (17) that encloses a discharge-type gas that can be excited in order to generate, either on its own or in combination with phosphor means (18) intended themselves to be excited by radiation transmitted by said gas, a visible light,
characterised in that it includes means for generating on one side of said chamber an evenly distributed electric field that can light up plasma in said gas, as well as, on the one hand, a matrix of controllable elements (19) that is arranged between the electric field and the gas, and on the other hand, means that control said elements (19) so that they individually modulate the electric field, and thus selectively generate the light areas on the screen.

2. Plasma display device that includes in a screen, a chamber (17) that encloses a discharge-type gas that can, from the effect of the electric field, generate, in combination with the phosphor means (18) intended to be excited by radiation transmitted by said gas, a visible light,
characterised in that it includes means for generating, on one side of said chamber, an evenly distributed electric field that can light and then maintain a plasma, as well as on the one hand, a matrix of controllable elements (19) that is positioned between the gas and the phosphors (18), and on the other hand, means that control said elements (19) so that they individually modulate the radiation emitted by the plasma and designed to be received by the phosphors (18), and thus selectively control the light that appears on the screen.

3. Plasma display device of the type that includes in a screen a chamber (17) that encloses a discharge-type gas that can be excited to generate, alone or in combination with phosphor means (18) themselves designed to be excited by radiation emitted from said gas, a visible light,
characterised in that it includes means for generating on one side of said chamber an evenly distributed electric field that can light up a plasma in said gas, as well as, on the one hand, a matrix of controllable elements (19) that is positioned downstream to the gas or phosphor means (18), and on the other hand, means that control said elements (19) so that they individually modulate the visible light generated and thus selectively control the light that appears on the screen.

4. Plasma display device according to claim 1, characterised in that the control means include at least two series of electrodes (X, Y) that extend in a network to control the controllable elements (19) in a matrix manner.

5. Plasma display device according to claim 1, characterised in that the controllable elements (19) include mechanical electro micro systems, and/or mechanical opto electro micro systems, and/or photonic band gap devices whose transmission status can be controlled.

6. Plasma display device according to claim 1, characterised in that the electric field is generated by microwave frequencies greater or equal to 200 MHz.

7. Plasma display device according to claim 1, characterised in that the means for generating the electric field include a two-dimensional network of microwave applicators.

8. Plasma display device according to claim 1, characterised in that the means for generating the electric field include parallel and phase-powered microwave resonators.

9. Plasma display device according to claim 1, characterised in that the chamber (17) that contains the gas is divided into cells (21, 22, 23) covered with phosphors (18.)

10. Plasma display device according to claim 9, characterised in that one cell (21; 22; 23) has a bottom covered with phosphors (18) along its entire surface.

11. Plasma display device according to claim 1, characterised in that the chamber (17) is divided into cells (21, 22, 23) containing mixtures of different gases that can generate radiation in different wavelengths.

12. Method for controlling a plasma display device of the type that includes in a screen a chamber (17) that encloses a discharge type gas that can be excited in order to generate a visible light, and that includes the following steps:
generating a uniformly distributed field (E) with an intensity that is greater than the field intensity necessary to light up a plasma in the gas,
modulating the generated field (E) to transmit it to a part of the plasma in order to selectively light, or maintain lit, or turn off said portion.

13. Method for controlling a plasma display device of the type that includes in a screen a chamber (17) that encloses a discharge type gas that can be excited in order to generate a visible light, and that includes the following steps:
generating a uniformly distributed field (E) with an intensity that is greater than the field intensity necessary to light up or maintain lit a plasma in the gas,
applying the field (E) to the gas to generate visible light or UV radiation,
modulating the radiation emitted by a portion of the plasma in order to selectively control the light that appears.

14. Method for controlling a plasma display device of the type that includes in a screen a chamber (17) that encloses a discharge type gas that can be excited in order to generate a visible light, and that includes the following steps:
generating a uniformly distributed field (E) with an intensity that is greater than the field intensity necessary to light a plasma in the gas,
applying the field (E) to the gas in order to generate ultraviolet radiation,
collecting the ultraviolet radiation and re-emit a visible radiation,
modulating the visible light radiation.
